(19) United States
(12) Patent Application Publication
(10) Pub. No.: US 2011/0180568 A1
(43) Pub. Date: Jul. 28, 2011

(54) Spray-all spray bottle and method of assembly

(76) Inventors: John Lloyd Gillispie, Rockville, MD (US); Therese Marie Palermino, Rockville, MD (US)

(21) Appl. No.: 12/930,831

(22) Filed: Jan. 19, 2011

Related U.S. Application Data
(60) Provisional application No. 61/336,121, filed on Jan. 19, 2010.

(51) Int. Cl. B67D 7/58

(52) U.S. Cl. 222/377

(57) ABSTRACT

The Spray-All Spray Bottle is a standard trigger-operated spray bottle with a unique base that allows the liquid to pool in the center so that most of the contents can be evacuated during normal use (except that which remains as a result of surface tension).

### CROSS REFERENCE TO RELATED APPLICATIONS

P 38 29 962.3-51

US 2006/0186144 A1 Sure Shot System

U.S. Pat. No. 5,062,549 Hand Held, Dip-Tube Style Liquid Dispenser

U.S. Pat. No. 4,470,526 Siphon Dispensing Bottle

### STATEMENT REGARDING FEDERALLY SPONSORED RESEARCH OR DEVELOPMENT

NA

### REFERENCE TO SEQUENCE LISTING, A TABLE, OR A COMPUTER PROGRAM LISTING COMPACT DISC APPENDIX

NA

### BACKGROUND OF THE INVENTION

The present invention is in the technical field of trigger operated spray bottles used to deliver cleaning products to soiled surface areas.

Conventional spray bottles are constructed such that a significant, useable portion remains behind; this bottle uses all of the liquid except that which remains behind as a result of surface tension of the liquid within, which varies from chemical to chemical, and except that which cannot be evacuated fully from within the dip tube in a standard trigger. This bottle also reflects what can in reality be produced using current spray bottle production methods of blow molding, injection molding and force fit processing.

Other two-part or one part spray bottles which claim an evacuation of most or all of the liquid is not account for surface tension that leaves small quantities of liquid of the sides and also do not account for liquid that remains in the dip tube as a result of air infusion as the majority of the liquid is used.

Other patents for two-part spray bottles teach that the reservoir in the center of the main bottle is threaded to attach base; This spray-bottle utilized a snap-in, force fitted attachment mechanism as shown in the attached drawings.

### BRIEF SUMMARY OF THE INVENTION

The invention is a trigger-operated spray bottle that allows all of the liquid to be evacuated during regular operation, except that which remains behind as a result of surface tension. It consists of two parts: A polyethylene teraphthalate (PET) blow molded spray-bottle (FIG. 1A) with an alteration in the base that essentially resembles an upside-down, shallow cone that, instead of a point, ends with a rounded indention in the base and a small indention around the side of the exterior of the bottle to accept (mate with) the second part (FIG. 4); the second part is an injection molded round base that is on the bottom and 1 inch tall around the side—it exists only to support the altered PET bottle (FIG. 1B) and (FIG. 5). The inside of this base has a circular protrusion around the inside of the base that is force fit into the corresponding indention around the PET bottle that accepts the base when forced on, allowing the two to “snap” together (FIG. 5 and FIG. 6). The wand or dip tube is just long enough to rest at the bottom of the indention in the upside-down cone; it can be flat (uncut), or have a slanted cut or a V-shaped cut at the bottom (FIG. 4).

### DEFINITIONS

Blow Molded—Blow molding is a manufacturing method used in the plastics and polymers industries to create hollow but strong containers for their clients. Plastic beverage bottles and fuel tanks are commonly created through blow molding. A typical blow molding machine set-up uses an extruded plastic preform and compressed air to fill the chamber of a divided mold. The two halves of the mold separate and the finished container is released.

Polyethylene—Polyethylene is a thermoplastic polymer consisting of long chains produced by combing the ingredient monomer ethylene (IUPAC name ethene), the name comes from the ingredient and not the actual chemical resulting. The ethylene actually converts to ethane as it takes its place in a polymer and straight sections of the polymer are the same structure as the simple chain hydrocarbons eg propane, decane and other straight single bonded carbon chains.

Injection Molded—Manufacturing process for producing parts from both thermoplastic and thermosetting plastic materials. Material is fed into a heated barrel, mixed, and forced into a mold cavity where it cools and hardens to the configuration of the mold cavity.[1] After a product is designed, usually by an industrial designer or an engineer, molds are made by a moldmaker (or toolmaker) from metal, usually either steel or aluminum, and precision-machined to form the features of the desired part.

Surface Tension—The cohesive forces between liquid molecules are responsible for the phenomenon known as surface tension. The molecules at the surface do not have other like molecules on all sides of them and consequently they cohere more strongly to those directly associated with them on the surface. This forms a surface “film” which makes it more difficult to move an object through the surface than to move it when it is completely submersed. Surface tension is typically measured in dynes/cm, the force in dynes required to break a film of length 1 cm. Equivalently, it can be stated as surface energy in ergs per square centimeter. Water at 20° C. has a surface tension of 72.8 dynes/cm compared to 22.3 for ethyl alcohol and 465 for mercury.

### BRIEF DESCRIPTION OF THE SEVERAL VIEWS OF THE DRAWING

FIG. 1 shows the spray bottle, FIG. 1A being the blow molded part and FIG. 1B the injection molded base.

FIG. 3 shows the interior of FIG. 1, wherein FIG. 3C is the blow molded portion and the unique shape of the lower portion of that part; FIG. 3B is the injection molded portion that supports the base.

FIG. 4 shows the dip tube (FIG. 3D) coming down to the center of the blow-molded portion.

FIGS. 5 and 6 show the snapped on portion, where injection molded portion mates with the blow-molded portion.

### DETAILED DESCRIPTION OF THE INVENTION

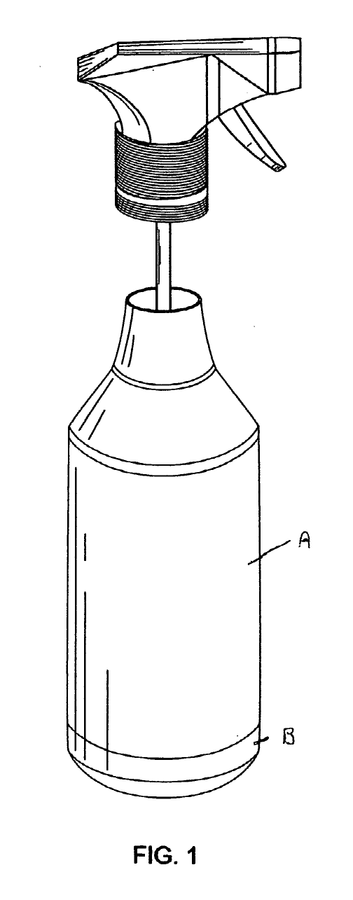

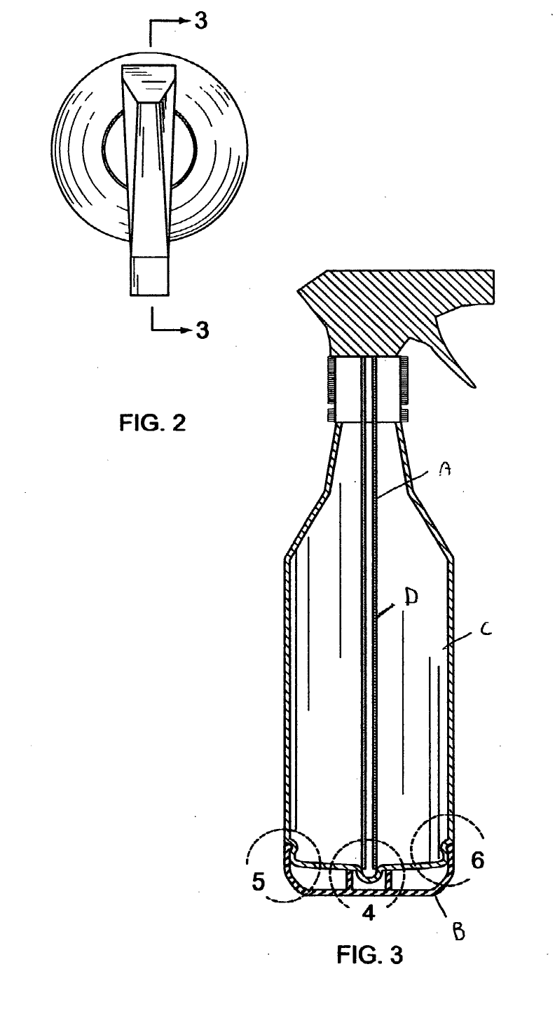

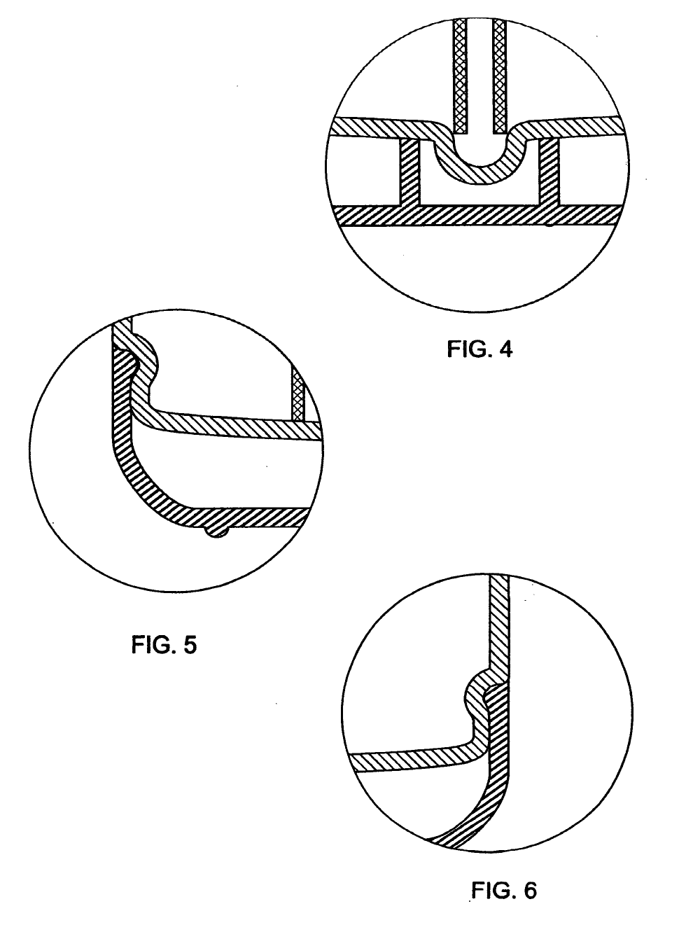

The overall shape of the Spray-All bottle is similar in size and use to that of a standard trigger operated spray bottle (FIG. 1, FIG. 2). FIG. 3 reveals the difference in the configuration of the base, which shows bottom of the blow molded portion of the bottle angling down until a point in the center (FIG. 4) that, prior to the exact center, goes into a rounded dip slightly larger than the dip tube. The dip tube (FIG. 3A) rests in this dip. The configuration could be described as a shallow, upside-down cone with a “nipple” or “dip” in the center.

The injection molded portion (FIG. 3B) is attached to the blow molded portion of the assembly by a raised “lip” that follows the circumference around the edge (FIG. 5, FIG. 6) and is forced fit into a corresponding depression in the side around the blow-molded portion of the bottle allowing it to snap in place when the injection molded portion is forced onto the blow molded portion.

1. This spray bottle uses most of the liquid, minus that quantity that remains as a result of surface tension of the liquid and how the liquid interacts with polyethylene. It also reflects what can in reality be produced with conventional manufacturing processes.
